(19) United States
(12) Patent Application Publication
(10) Pub. No.: US 2024/0382850 A1
(43) Pub. Date: Nov. 21, 2024

(54) SKILL ACQUISITION BASED ON VIRTUAL SCENE

(71) Applicant: Tencent Technology (Shenzhen) Company Limited, Shenzhen (CN)

(72) Inventors: Yiqi LI, Shenzhen (CN); Ya ZHANG, Shenzhen (CN); Han WEN, Shenzhen (CN); Yinchao CHEN, Shenzhen (CN); Luyu SUN, Shenzhen (CN); Huizhong ZHANG, Shenzhen (CN); Lijin WANG, Shenzhen (CN)

(73) Assignee: Tencent Technology (Shenzhen) Company Limited, Shenzhen (CN)

(21) Appl. No.: 18/786,194

(22) Filed: Jul. 26, 2024

Related U.S. Application Data
(63) Continuation of application No. PCT/CN2023/102280, filed on Jun. 26, 2023.

(30) Foreign Application Priority Data
Aug. 30, 2022 (CN) 202211045452.2

(51) Int. Cl. A63F 13/55; A63F 13/52; A63F 13/822

(52) U.S. Cl. CPC A63F 13/55; A63F 13/52; A63F 13/822

(57) ABSTRACT

A method includes displaying a first virtual tribe in a virtual scene, the first virtual tribe is a virtual tribe with one or more first virtual objects of a first identity type in the virtual scene. The method includes displaying social interaction options for an acquisition of one or more skills across different virtual tribe. The social interaction options include identification information of a second virtual tribe, and candidate skill options for a second set of skills associated with the second virtual. The method further includes receiving a selection operation on a first skill option among the candidate skill options. The first skill option corresponds to a first skill in the second set of skills associated with the second virtual tribe. The selection operation on the first skill option indicates a triggering of an acquisition of the first skill corresponding to the first skill option.

### RELATED APPLICATIONS

The present application is a continuation of International Application No. PCT/CN2023/102280, filed on Jun. 26, 2023, and entitled “VIRTUAL SCENE-BASED SKILL ACQUISITION METHOD AND APPARATUS, DEVICE, MEDIUM, AND PRODUCT, which claims priority to Chinese Patent Application No. 202211045452.2, filed on Aug. 30, 2022. and entitled “SKILL ACQUISITION METHOD, APPARATUS, DEVICE, MEDIUM, AND PRODUCT BASED ON VIRTUAL SCENE.” The entire disclosures of the prior applications are hereby incorporated by reference.

### FIELD OF THE TECHNOLOGY

This disclosure relates to the technical field of computers, including a skill acquisition method, apparatus, device, medium, and product based on a virtual scene.

### BACKGROUND OF THE DISCLOSURE

With the rapid development of computer technologies and the diversification of terminals, the application of electronic games is becoming widespread. Strategy games are relatively popular. In a strategy game, virtual scenes are displayed through terminal devices, and players can control virtual objects to complete game tasks in the virtual scenes by formulating game strategies, so as to promote the development of a game plot.

In the related art, due to the fact that virtual objects of different identity types own different skills, when a player selects an identity type of a virtual object, the player may change the identity type of the virtual object, so that the virtual object acquires skills corresponding to other identity types.

However, in the related art, to acquire skills corresponding to a plurality of different identity types, the player needs to perform identity type transform for a plurality of times. The identity type transform is difficult, and the acquisition of skills is not convenient enough.

### SUMMARY

Embodiments of the present disclosure provide a skill acquisition method, apparatus, device, medium, and product based on a virtual scene. Examples of technical solutions are as follows.

An aspect provides a skill acquisition method based on a virtual scene, performed by a terminal device. The method includes displaying a first virtual tribe in the virtual scene, the first virtual tribe is a virtual tribe with one or more first virtual objects of a first identity type in the virtual scene, a first set of skills is associated with the first virtual tribe. The method also includes displaying social interaction options for an acquisition of one or more skills across different virtual tribe by at least a first virtual object in the one or more first virtual objects of the first identity type. The social interaction options include identification information of a second virtual tribe, and candidate skill options for a second set of skills associated with the second virtual tribe. The second virtual tribe is a virtual tribe with one or more second virtual objects of a second identity type in the virtual scene. The method also includes receiving a selection operation on a first skill option among the candidate skill options, the first skill option corresponds to a first skill in the second set of skills associated with the second virtual tribe, the selection operation on the first skill option indicates a triggering of an acquisition of the first skill corresponding to the first skill option. The method also includes when the acquisition of the first skill is completed, displaying the first skill in a skill list of candidate skills for use by the first virtual object in the one or more first virtual objects of the first identity type in a process that the first virtual object of the first identity type participates in a virtual battle.

Another aspect provides a skill acquisition apparatus based on a virtual scene, the apparatus includes processing circuitry. The processing circuitry is configured to display a first virtual tribe in a virtual scene, the first virtual tribe is a virtual tribe with one or more first virtual objects of a first identity type in the virtual scene, a first set of skills is associated with the first virtual tribe. The processing circuit is further configured to display social interaction options for an acquisition of one or more skills across different virtual tribe by at least a first virtual object in the one or more first virtual objects of the first identity type, the social interaction options includes identification information of a second virtual tribe, and candidate skill options for a second set of skills associated with the second virtual tribe, the second virtual tribe is a virtual tribe with one or more second virtual objects of a second identity type in the virtual scene, and the second set of skills associated with the second virtual tribe is associated with the one or more second virtual objects of the second identity type. The processing circuitry is configured to receive a selection operation on a first skill option among the candidate skill options, the first skill option corresponding to a first skill in the second set of skills associated with the second virtual tribe, the selection operation on the first skill option indicates a triggering of an acquisition of the first skill corresponding to the first skill option. The processing circuitry is also configured to, when the acquisition of the first skill is completed, display the first skill in a skill list of candidate skills for use by a first virtual object in the one or more first virtual objects of the first identity type in a process that the first virtual object participates in a virtual battle3or.

Another aspect provides a terminal device, the terminal device including a processor and a memory, the memory having at least one program stored therein, and the at least one program being loaded and executed by the processor to implement a skill acquisition method based on a virtual scene described above.

Another aspect provides a non-transitory computer-readable storage medium, the storage medium having at least one program stored therein, and the at least one program being loaded and executed by a processor to implement a skill acquisition method based on a virtual scene described above.

Another aspect provides a computer program product, the computer program product including a computer instruction, and the computer instruction being stored in a computer-readable storage medium. A processor of a terminal device reads the computer instruction from the computer-readable storage medium, and the processor executes the computer instruction, to cause the terminal device to perform a skill acquisition method based on a virtual scene described above.

Technical solutions provided in the embodiments of the present disclosure include, for example, the following beneficial effects:

Through the social interaction options between the first virtual tribe and the second virtual tribe, the virtual object of the first identity type in the first virtual tribe can acquire the skills owned by the virtual object of the second identity type in the second virtual tribe, so that when an identity type of a virtual object is determined, skills corresponding to other identity types can be acquired without transferring the identity type of the virtual object. Therefore, the convenience of acquisition of skills between different identity types is improved, and in particular, when skills corresponding to a plurality of different identity types need to be acquired, both the convenience of acquisition of skills and the acquisition efficiency are high.

In addition, after triggering the social interactions between different virtual tribes, skills owned by virtual objects of different identity types are acquired, so that during a virtual battle, a virtual object can own all of the skills corresponding to the different identity types without changing the identity type, thereby improving the diversity of skill acquisition, avoiding a plurality of times of identity type transforms of a user in the process of acquiring skills corresponding to the different identity types, and reducing the data overhead of the computer.

### BRIEF DESCRIPTION OF THE DRAWINGS

FIG. 1 is a schematic diagram of a skill acquisition method based on a virtual scene according to an embodiment of this disclosure.

FIG. 2 is a schematic diagram of an implementation environment according to an embodiment of this disclosure.

FIG. 3 is a structural block diagram of an electronic device according to an embodiment of this disclosure.

FIG. 4 is a flowchart of a skill acquisition method based on a virtual scene according to an embodiment of this disclosure.

FIG. 5 is a flowchart of a skill acquisition method based on a virtual scene according to another embodiment of this disclosure.

FIG. 6 is a schematic diagram of a skill acquisition method based on a virtual scene according to an embodiment of this disclosure.

FIG. 7 is a schematic diagram of an acquisition time according to an embodiment of this disclosure.

FIG. 8 is a flowchart of a skill acquisition method based on a virtual scene according to another embodiment of this disclosure.

FIG. 9 is a schematic diagram of a first skill according to an embodiment of this disclosure.

FIG. 10 is a schematic diagram of acquisition completion prompt information according to an embodiment of this disclosure.

FIG. 11 is a flowchart of a skill acquisition method based on a virtual scene according to another embodiment of this disclosure.

FIG. 12 is a structural block diagram of a skill acquisition apparatus based on a virtual scene according to an embodiment of this disclosure.

FIG. 13 is a structural block diagram of a skill acquisition apparatus based on a virtual scene according to an embodiment of this disclosure.

FIG. 14 is a structural block diagram of a terminal device according to an embodiment of this disclosure.

### DESCRIPTION OF EMBODIMENTS

To make the objectives, technical solutions, and advantages of this disclosure clearer, the following further describes implementations of this disclosure in detail with reference to the accompanying drawings.

Examples of embodiments are described in detail herein, and examples of the embodiments are shown in the accompanying drawings. When the following description involves the accompanying drawings, unless otherwise indicated, the same numerals in different accompanying drawings represent the same or similar elements. The implementations described in the following embodiments do not represent all implementations consistent with this disclosure. On the contrary, the implementations are merely examples of apparatuses and methods that are described in detail in the appended claims and that are consistent with some aspects of this disclosure.

First, examples terms involved in the embodiments of the present disclosure are briefly introduced. The description of the terms are provided as examples only and are not intended to limit the scope of the disclosure.

Virtual environment: A virtual environment may refer to a virtual environment displayed (or provided) when an application is run on a terminal device. The virtual environment may be a simulated environment of the real world, a semi-simulated and semi-fictional environment, or a purely fictional environment. The virtual environment may be any one of the following: a two-dimensional virtual environment, a 2.5-dimensional virtual environment, and a three-dimensional virtual environment. In the following embodiments, an example in which the virtual environment is a two-dimensional virtual environment is used for description.

Virtual object: A virtual object may refer to a movable object in a virtual environment. The movable object may be a virtual chess piece, a virtual character, a virtual animal, or an anime character, for example: characters, animals, plants, oil drums, walls, stones, or the like displayed in the virtual environment. In one embodiment, the virtual object is a three-dimensional model, a two-dimensional plane model, or the like created based on an animation skeleton technology. Each virtual object has a shape and a volume in the virtual environment, and occupies some space in the virtual environment.

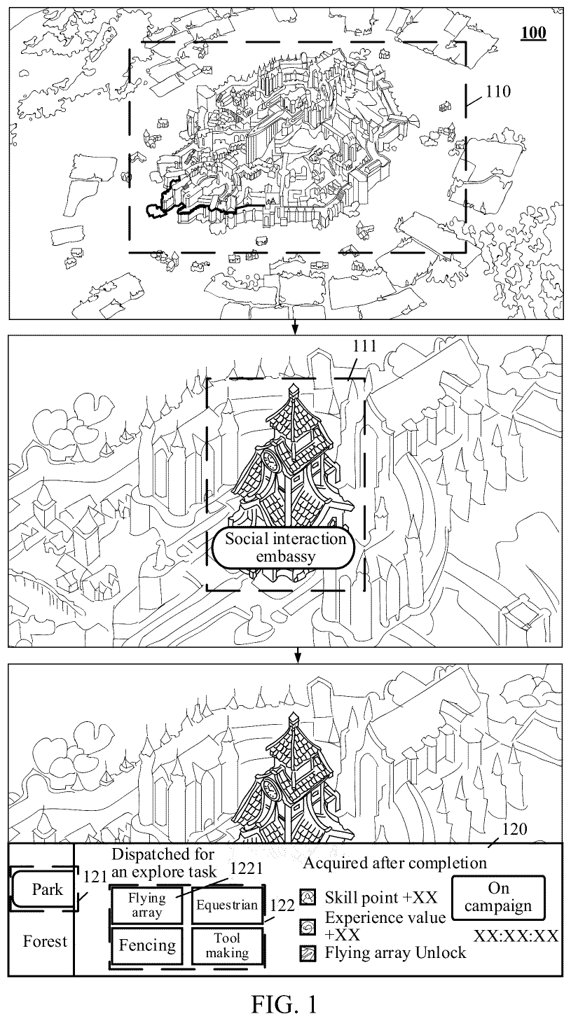

First, referring to FIG. 1, FIG. 1 is a schematic diagram of a skill acquisition method based on a virtual scene according to an embodiment of this disclosure. As shown in FIG. 1, a client displays a virtual scene 100, the virtual scene 100 includes a first virtual tribe 110, and the first virtual tribe 110 is a virtual tribe corresponding to a virtual object of a first identity type. In this embodiment, the first virtual tribe 110 is named “Temple base camp”. The “Temple base camp” includes a first virtual building 111 “Social interaction embassy” for initiating a social interaction between virtual tribes. The social interaction in this embodiment includes acquiring skills owned by virtual objects in different virtual tribes. The first virtual building in this embodiment may alternatively be referred to as a designated virtual building. While embodiments of the present disclosure are described using a virtual tribe as an example, the embodiments may be applied to other virtual groups.

In response to a trigger operation of a user on the first virtual building 111, the client displays social interaction options 120. The social interaction options 120 include identification information “Park” of a second virtual tribe 121 and candidate skill options 122 corresponding to the second virtual tribe 121. In this embodiment, the second virtual tribe 121 is a virtual tribe of a virtual object of a second identity type, a skill “Flying array”, a skill “Equestrian”, a skill “Fencing”, and a skill “Tool making” respectively corresponding to the four candidate skill options 122 are skills owned by the virtual object of the second identity type. The second identity type is different from the first identity type. The first virtual tribe 110 is different from the second virtual tribe 121. The skills corresponding to the second identity type are exclusive skills corresponding to the second identity type, which are not owned by the virtual object of the first identity type.

After a selection operation on a first skill option 1221 among the candidate skill options 122 is received, the client starts to perform logic of acquiring a first skill “Flight array” corresponding to the first skill option 1221. When acquisition of the first skill is completed, the client adds the first skill to a skill list corresponding to the virtual object of the first identity type. In a process in which the virtual object of the first identity type participates in a virtual battle, the client displays the first skill “Flying array” in the skill list of the virtual object. In other words, the skill list of the current virtual object includes skills owned by the first identity type and the acquired first skill corresponding to the second identity type. The first skill option may refer to any candidate skill option among the plurality of candidate skill options, and the first skill option in this embodiment may alternatively be referred to as a target skill option.

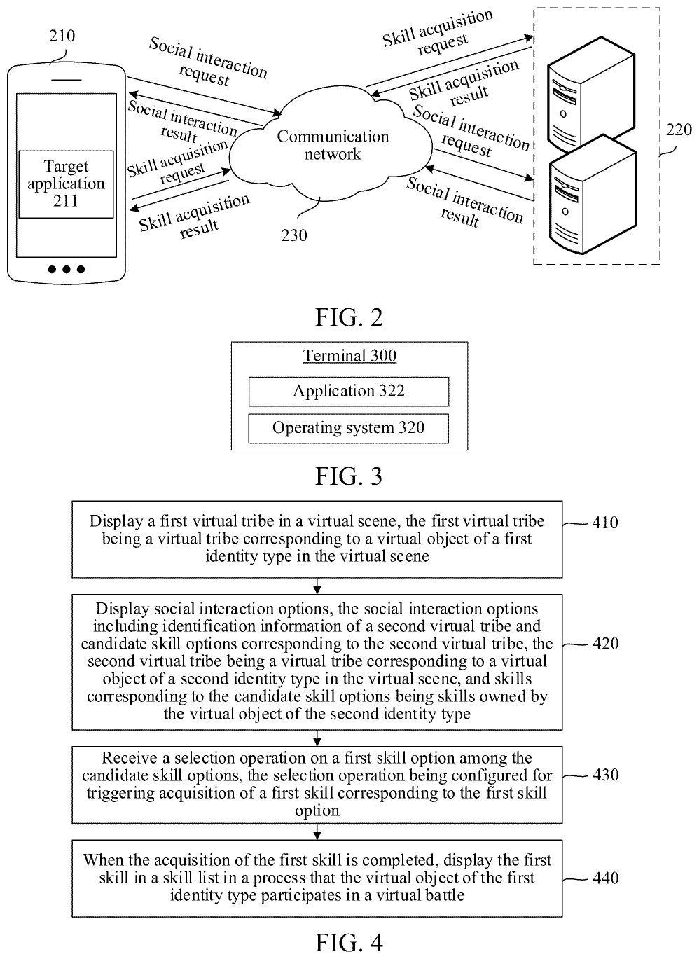

Next, an implementation environment of this disclosure is introduced below. Referring to FIG. 2, FIG. 2 is a schematic diagram of an implementation environment according to an embodiment of this disclosure. The implementation environment includes: a terminal 210, a server 220, and a communication network 230, where the terminal 210 and the server 220 are connected through the communication network 230.

A target application 211 is installed and run on the terminal 210, where the target application 211 is an application supporting a two-dimensional virtual environment or a three-dimensional virtual environment. The target application 211 may be, for example, a virtual reality application, a three-dimensional map program, a self-moving chess game, a strategy game, a puzzle game, a third-person shooting game (TPS), a first-person shooting game (FPS), a multiplayer online battle arena game (MOBA), or a multiplayer gunfight type survival game. In one practical implementation, the target application 211 may be a stand alone-version application, such as a stand alone-version three-dimensional game program, or may be a network online-version application. The terminal in this embodiment may alternatively be referred to as a terminal device.

In one embodiment, when the target application 211 is implemented as a stand alone-version application, a client corresponding to the target application 211 displays a first virtual tribe in a virtual scene, the first virtual tribe being a virtual tribe corresponding to a virtual object of a first identity type; and when receiving a trigger operation on a first virtual building in the first virtual tribe, the client displays social interaction options including identification information of a second virtual tribe and candidate skill options corresponding to the second virtual tribe, where skills corresponding to the candidate skill options are skills owned by a virtual object of a second identity type, and the virtual object of the second identity type corresponds to the second virtual tribe. When receiving a selection operation on a first skill option, the client controls the virtual object of the first identity type to start acquiring a first skill corresponding to the first skill option. When acquisition of the first skill is completed, the client adds the first skill to a skill list corresponding to the virtual object of the first identity type. Subsequently, in a process that the virtual object of the first identity type is in a battle, the client displays the acquired first skill in the skill list.

In one embodiment, when the target application 211 is implemented as a network online-version application, for example, the target application 211 may be implemented as a strategy game, a client installed and run on the terminal 210 displays a first virtual tribe in a virtual scene, and in response to a trigger operation on a first virtual building in the first virtual tribe, the client generates a social interaction request and transmits the social interaction request to the server 220, where the social interaction request is configured for requesting to initiate a social interaction between different virtual tribes.

After receiving the social interaction request transmitted by the client, the server 220 determines, according to the social interaction request, rendering data corresponding to the second virtual tribe and rendering data of candidate skill options corresponding to the second virtual tribe, to generate a social interaction option, and the server 220 feeds back the social interaction option to the client as a social interaction result.

After receiving the social interaction result, the client installed and run on the terminal 210 performs interface rendering on the virtual scene according to the rendering data, and displays identification information of the second virtual tribe and the candidate skill options corresponding to the second virtual tribe, where skills corresponding to the candidate skill options are skills owned by a virtual object of a second identity type, and the virtual object of the second identity type pertains to the second virtual tribe. In response to a selection operation on a first skill option among the candidate skill options, the client generates a skill acquisition request and transmits the skill acquisition request to the server 220, where the skill acquisition request is configured for requesting to acquire a first skill corresponding to the first skill option.

After receiving the skill acquisition request transmitted by the client, the server 220 fills in a skill library corresponding to the virtual object of the first identity type with skill information corresponding to the first skill (for example, a skill name, or a skill attribute), and generates a skill acquisition result based on a skill filling result, and then the server 220 feeds back the skill acquisition result to the client, where the skill filling result is configured for indicating that the virtual object of the first the entity type has currently acquired the first skill.

After receiving the skill acquisition result, in a subsequent process of controlling the virtual object of the first identity type to perform a virtual battle, the client displays the first skill in the skill list, for a user to select the first skill to perform the virtual battle.

In some embodiments, the terminal 210 above is optional, for example, any terminal on which the target application 211 is installed and run. The terminal may be an electronic device in various types, such as a desktop computer, a laptop portable computer, a mobile phone, a tablet computer, an e-book reader, a moving picture experts group audio layer III (MP3) player, a moving picture experts group audio layer IV (MP4) player, a smart television, or an in-vehicle device, which is not limited in the embodiments of the present disclosure.

For example, referring to FIG. 3, FIG. 3 is a structural block diagram of an electronic device according to an embodiment of this disclosure. The electronic device 300 includes: an operating system 320 and an application 322.

The operating system 320 is underlying software that provides secure access to computer hardware for the applications 322.

The application 322 is an application supporting a virtual environment. In one embodiment, the application 322 is an application supporting a three-dimensional virtual environment. The application 322 may be any one of the following: a virtual reality application, a three-dimensional map program, a third-person shooting game, a first-person shooting game, a multiplayer online battle arena game, a multiplayer online battle arena game, a puzzle game, or a strategy game. The application 322 may be a stand alone-version application, such as a stand alone-version game program, or may be a network online-version application.

The server 220 may be any one of the following: one server, a plurality of servers, a cloud computing platform, or a virtualized center. The server 220 may be a back-end server of the terminal 210. In one embodiment, in an implementation process of the target application 211, the server 220 undertakes primary computing work and the terminal 210 undertakes secondary computing work; or the server 220 undertakes secondary computing work, and the terminal 210 undertakes primary computing work; or the server 220 and the terminal 210 perform collaborative computing by using a distributed computing architecture therebetween, which is not limited in the embodiments of the present disclosure.

The server above may be an independent physical server, or a server cluster or distributed system composed of a plurality of physical servers, or may be a cloud server that provides cloud services, cloud databases, and basic cloud services such as cloud computing, cloud functions, cloud storage, network services, cloud communications, middleware services, domain name services, security services, content delivery networks (CDN), big data, and artificial intelligence platforms.

The cloud technology refers to a hosting technology that unifies series of resources such as hardware, software, and network in a wide area network or a local area network, to implement computing, storage, processing, and sharing of data.

In some embodiments, the server may alternatively be implemented as a node in a blockchain system.

In the present disclosure, before collecting relevant data of users and during the process of collecting the relevant data of the users, a prompt interface or a pop-up window is displayed, or voice prompt information is outputted, and the prompt interface, the pop-up window, or the voice prompt information is configured for prompting the users that relevant data of the users are currently collected, so that in the present disclosure, a related operation of acquiring user-related data is started only after acquiring confirmation operations, transmitted by the users, for the prompt interface or the pop-up window, or otherwise (that is, no confirmation operations, transmitted by the user, for the prompt interface or the pop-up window are acquired), the related operation of acquiring the user-related data is ended, that is, the user-related data is not acquired.

In combination with above introduction, the skill acquisition method based on a virtual scene provided in some embodiments of the present disclosure is described. The method may be performed by a terminal, or may be jointly performed by a server and a terminal. In the embodiments of the present disclosure, for example, the method is performed by a terminal (for example, a client installed and run on the terminal). As shown in FIG. 4, the method includes the following operations.

Operation 410: Display a first virtual tribe in the virtual scene, the first virtual tribe being a virtual tribe corresponding to a virtual object of a first identity type in the virtual scene.

The virtual tribe in this embodiment of the disclosure may refer to a virtual building cluster, such as a virtual village, a virtual castle, or a virtual town, which may be configured for representing a gathering place of a particular type of virtual objects. Schematically, the first virtual tribe may be configured for representing a gathering place of a virtual object of a first identity type, the first virtual tribe may further be configured for representing a collective formed by combining a plurality of virtual objects of the first identity type. In other words, the first virtual tribe includes a plurality of virtual objects and the plurality of virtual objects are all of the first identity type. The virtual scene may refer to a scene provided by the client of the target application.

In one embodiment, a plurality of tribe members in the first virtual tribe are a same virtual object, for example, the virtual objects in the first virtual tribe have a same appearance; Or, a plurality of tribe members in the first virtual tribe are of a same identity type but are different virtual objects, for example, the virtual objects in the first virtual tribe have different appearances, which is not limited in the embodiments of the present disclosure.

The first identity type is an identity type selected by a user account that logs into a current client, and the identity type may be configured for representing an identity type corresponding to each virtual object in a same virtual tribe. For example: If the first virtual tribe is a tribe A, the tribe A includes a tribe member having an identity type of “Member A”. In one embodiment, the identity type may be set by a designer of the application. A style of the first virtual tribe is correlated with the first identity type, and if the first identity type is “Knight”, the style of the first virtual tribe may be: a virtual castle. A skill corresponding to the first virtual tribe is correlated with the first identity type, the first identity type may determine a skill that can be owned by the first virtual tribe, and skills of identity types are different.

Operation 420: Display social interaction options, the social interaction options including identification information of a second virtual tribe and candidate skill options corresponding to the second virtual tribe, the second virtual tribe being a virtual tribe corresponding to a virtual object of a second identity type in the virtual scene, and skills corresponding to the candidate skill options being skills owned by the virtual object of the second identity type.

The social interaction options are configured for a user to select which skill to acquire from the second virtual tribe. For example, the social interaction options include a plurality of candidate skill options corresponding to the second virtual tribe, and each candidate skill option corresponds to an exclusive skill of the second virtual tribe. The identification information of the second virtual tribe is configured for uniquely identifying the second virtual tribe, such as a name, a number, or an iconic virtual building.

In some embodiments, the second virtual tribe and the first virtual tribe are different virtual tribes. In other words, a virtual object in the first virtual tribe and a virtual object in the second virtual tribe correspond to different identity types. The second virtual tribe may refer to any virtual tribe other than the first virtual tribe. The identification information of the second virtual tribe is configured for uniquely identifying the second virtual tribe.

In some embodiments, virtual objects corresponding to different virtual tribes are of different identity types, and therefore the virtual objects of different identity types are of different skill types. For example: the ““Member”” owns a skill ““Scratc””, and a ““Member”” owns a skill ““Absorb energ””. The member A and the member B are virtual objects having different identity types. Therefore, the skill ““Scratc”” is a designated skill owned by the member A and ““Absorb energ”” is a designated skill owned by the member B.

In one embodiment, the candidate skill options include an option of a skill owned by the virtual object of the second identity type and not yet acquired by the virtual object of the first identity type; or the candidate skill options include an option of a skill owned by the virtual object of the second identity type and acquired by the virtual object of the first identity type, and an option of a skill owned by the virtual object of the second identity type and not yet acquired by the virtual object of the first identity type, which is not limited in the embodiments of the present disclosure.

In an example, the first virtual tribe includes a first virtual building, and the first virtual building is configured for initiating a social interaction between virtual tribes, and in other words, different virtual tribes may perform a social interaction through the first virtual building. The first virtual building may refer to an iconic building in the virtual tribe, or may be a selected building by various techniques, which is not limited in the embodiments of the present disclosure. For example, in response to a click/tap operation of a user on the first virtual building, the client displays social interaction options in a user interface, and further implements a social interaction between the virtual tribes based on the social interaction options.

The social interaction between the virtual tribes refers to a process of implementing an activity interaction between different virtual tribes. For example, the social interaction may be implemented as a social activity between virtual tribes, or the social interaction may be implemented as a social activity between a virtual object in a virtual tribe and a virtual object in another virtual tribe, or the social interaction further includes exchange of skills between virtual objects of different virtual tribes. For example, a virtual object in the current virtual tribe may acquire a skill owned by a virtual object in the other virtual tribe through a social interaction with the other virtual tribe, which is not limited in the embodiments of the present disclosure.

In one embodiment, the first virtual building is configured for providing a virtual scene of performing a social interaction between different virtual tribes. In other words, the current virtual object of the first identity type initiates a social interaction with a virtual object corresponding to the other virtual tribe at a designated position corresponding to the first virtual building. For example: a virtual object A of the first identity type and a virtual object B of the second identity type may exchange skills in a first virtual building ““Skill exchange hal”” so that the virtual object A can own a skill of the virtual object B and the virtual object B can own a skill of the virtual object A.

Alternatively, the first virtual building may be configured for providing social interaction virtual objects that are individually targeted at a social interaction between different virtual tribes. In other words, an interaction between different virtual tribes is implemented through social interaction virtual objects in the first virtual building. For example: when a virtual object a of the first identity type wants to own a skill owned by a virtual object of the second identity type in the second virtual tribe, the virtual object a may dispatch a social interaction virtual object ““Social interaction messenge””, to the second virtual tribe through the first virtual building, ““Social interaction embass””, the social interaction virtual object is configured for autonomously go to the second virtual tribe, to perform exchange of skills with the virtual object of the second identity type, and after the social interaction messenger returns to the social interaction embassy, the social interaction messenger feeds back the skill corresponding to the second identity type obtained by the exchange to the virtual object a, so that the virtual object a can own the skill corresponding to the second identity type.

Operation 430: Receive a selection operation on a first skill option among the candidate skill options, the selection operation being configured for triggering acquisition of a first skill corresponding to the first skill option.

In one embodiment, a user may select the first skill option by using a display screen of the terminal device, or may select the first skill option by using an external device (for example, a keyboard, a mouse, or a handle) of the terminal device. The client detects the first skill option in real time to receive the selection operation.

For example, the selection operation is configured for triggering the virtual object of the first identity type to acquire the first skill owned by the virtual object of the second identity type. In one embodiment, the selection operation includes at least one of the following: click/tap, slide, double click/tap, or the like.

In one embodiment, the first skill corresponding to the first skill option is a skill corresponding to the second identity type and not yet acquired by the virtual object of the current first identity type; or the first skill corresponding to the first skill option is a skill corresponding to the second identity type and acquired by the virtual object of the current first identity type, which is not limited in the embodiments of the present disclosure.

After the acquisition of the first skill by the virtual object of the first identity type is completed, the selection operation is implemented as a skill attribute effect of improving the first skill. In other words, in response to that the user performs a selection operation on the first skill option again, the client no longer triggers the virtual object of the first identity type to acquire the first skill, but instead, triggers a skill attribute effect of improving the first skill. For example: after the first skill is acquired, the first skill is currently implemented as increasing the defense by 10%. If a selection operation on the first skill option is received again, the selection operation is configured for promoting the first skill by increasing the defense by 15%.

In one embodiment, the selection operation includes selecting one first skill option at a time; or the selection operation includes selecting a plurality of first skill options at a time, which is not limited in the embodiments of the present disclosure. In one embodiment, a single first skill option corresponds to a single first skill; or a single first skill option corresponds to a plurality of first skills, which is not limited in the embodiments of the present disclosure.

Operation 440: When the acquisition of the first skill is completed, display the first skill in a skill list in a process that the virtual object of the first identity type participates in a virtual battle.

In one embodiment, completion of the acquisition of the first skill includes at least one of the following situations.

1. The completion of the acquisition of the first skill means that the virtual object of the first identity type currently owns the virtual skill. In other words, the virtual object of the first identity type can use the first skill. For example, when an acquisition duration of the first skill meets a duration threshold, the client may determine that the acquisition of the first skill is completed.

2. The completion of the acquisition of the first skill means that a skill attribute effect corresponding to the first skill is acquired, and the skill attribute effect is added to the skills inherently owned by the virtual object of the first identity type, so that a gain in the attribute effect of the skill is achieved. For example, when a gain in the attribute effect of the skill inherently owned by the virtual object of the first identity type is detected, the client may determine that the acquisition of the first skill is completed.

3. The completion of the acquisition of the first skill means that an acquisition progress of the first skill reaches a preset proportion threshold. For example, a complete attribute effect of the first skill is recorded as 100%, and when the acquisition progress of the first skill reaches 80%, the client may determine that the acquisition of the first skill is completed, but the acquired first skill only has an attribute effect of 80% of the first skill.

4. The completion of the acquisition of the first skill means that the virtual object of the first identity type completes a designated task. For example, when the virtual object of the first identity type completes the designated task, the client may determine that the acquisition of the first skill is completed.

The foregoing completions of the acquisition of the first skill are merely schematic examples, which is not limited in the embodiments of the present disclosure.

The skill list is configured for displaying skills. The skill list may include a plurality of options of already owned skills, and a user may select a skill by triggering an option of the skill. In one embodiment, when the acquisition of the first skill is completed, the client adds the option of the first skill to the skill list of the virtual object of the first identity type.

The virtual battle may refer to a battle obtained by simulating a real battle, or a fictional battle. The virtual battle in the embodiments of the present disclosure may refer to a battle between a plurality of virtual tribes, or may refer to a battle between a virtual tribe and a non-player character (NPC), which is not limited in the embodiments of the present disclosure. In some embodiments, in a process in which the virtual object of the first identity type participates in a virtual battle, options of a plurality of candidate skills are displayed in a skill list, the candidate skills refer to skills already owned by the virtual object of the first identity type, including the skills inherently owned by the virtual object of the first identity type and the first skills acquired through the selection operation.

In one embodiment, the virtual object of the first identity type may use the first skill in the skill list separately during a virtual battle; or the virtual object of the first identity type may combine the first skill and a skill inherently owned by the virtual object of the first identity type during a virtual battle; or, during a virtual battle, the virtual object of the first identity type summons, by triggering the first skill, a virtual object of the second identity type to jointly participate in the battle, which is not limited in the embodiments of the present disclosure.

In one embodiment, if the virtual object of the first identity type uses the first skill during a virtual battle, the option of the first skill is still displayed in the skill list in a next virtual battle, and in other words, the current first skill is a fixed skill that the virtual object of the first identity type owns for a long time; or, if the virtual object of the first identity type uses the first skill in a current virtual battle, in a next virtual battle, the option of the first skill is no longer displayed in the skill list, in other words, the first skill is implemented as a single effective skill, and in other words, if the first skill is used in a virtual battle, the virtual object of the first identity type no longer owns the first skill in a next virtual battle, which is not limited in the embodiments of the present disclosure.

In one embodiment, the first skill is displayed in the skill list side by side with the skills inherently owned by the virtual object of the first identity type; or the first skill is separately displayed at a designated position in the skill list, which is not limited in the embodiments of the present disclosure.

To sum up, in the skill acquisition method based on a virtual scene provided in the embodiments of the present disclosure, through the social interaction options between the first virtual tribe and the second virtual tribe, the virtual object of the first identity type in the first virtual tribe can acquire the skills owned by the virtual object of the second identity type in the second virtual tribe, so that when an identity type of a virtual object is determined, skills corresponding to other identity types can be acquired without transferring the identity type of the virtual object. Therefore, the convenience of acquisition of skills between different identity types is improved, and in particular, when skills corresponding to a plurality of different identity types need to be acquired, both the convenience of acquisition of skills and the acquisition efficiency are high.

In addition, after triggering the social interactions between different virtual tribes, skills owned by virtual objects of different identity types are acquired, so that during a virtual battle, a virtual object can own all of the skills corresponding to the different identity types without changing the identity type, thereby improving the diversity of skill acquisition, avoiding a plurality of times of identity type transforms of a user in the process of acquiring skills corresponding to the different identity types, and reducing the data overhead of the computer.

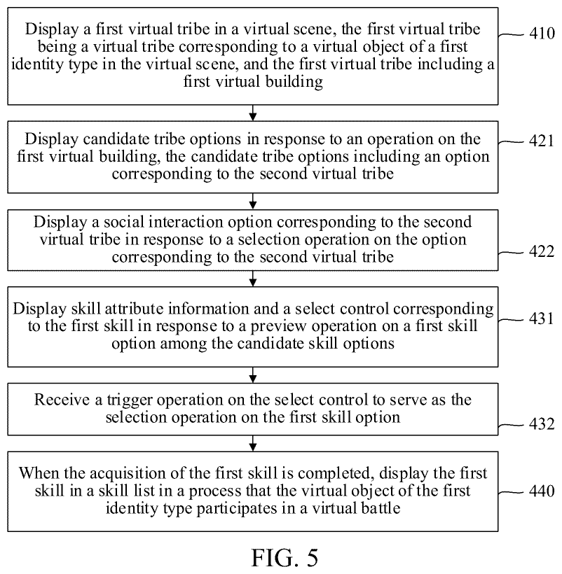

In one embodiment, the first virtual building may further be configured for determining a virtual tribe for performing a social interaction. For example, referring to FIG. 5, FIG. 5 is a flowchart of a skill acquisition method based on a virtual scene according to another embodiment of the present disclosure. In other words, foregoing operation 420 includes operation 421 and operation 422, and operation 430 includes operation 431 and operation 432. As shown in FIG. 5, the method includes the following operations.

Operation 410: Display a first virtual tribe in a virtual scene, the first virtual tribe being a virtual tribe corresponding to a virtual object of a first identity type in the virtual scene, and the first virtual tribe including a first virtual building.

Operation 410 is the same as that described in the foregoing embodiment. For content not described in this embodiment of the present disclosure, reference may be made to the foregoing embodiment, and details are not described herein again.

Operation 421: Display candidate tribe options in response to an operation on the first virtual building, the candidate tribe options including an option corresponding to the second virtual tribe.

In one embodiment, in response to a click/tap operation of a user on the first virtual building, the client displays a plurality of candidate tribe options in the user interface, and each candidate tribe option corresponds to one candidate virtual tribe. The candidate tribe option refers to an option corresponding to a candidate virtual tribe with which the virtual object of the first identity type can perform a social interaction. In one embodiment, the candidate tribe option is configured for representing at least one other virtual tribe that with which the virtual object of the first virtual tribe (for example: the second virtual tribe) can perform a social interaction.

For example, display content of the candidate tribe option includes at least one of the following.

1. The candidate tribe option includes tribe information corresponding to the candidate virtual tribe. For example: a tribe name or an identity type of a virtual object in the tribe.

2. The candidate tribe option includes a skill type owned by an virtual object of the candidate virtual tribe. For example: for a candidate tribe option ““Member””, ““Skill type: Attack skil”” is displayed on a right side of ““Member””.

3. The candidate tribe option includes a number of times by which the candidate virtual tribe is selected within a historical period of time. In other words, how many users perform a selection operation on the candidate tribe option within the historical period of time. For example: for a candidate tribe option ““Member””, ““Number of people that historically perform the selection: 65”” is displayed below ““Member””.

The foregoing display content about the candidate tribe option is merely a schematic example, which is not limited in the embodiments of the present disclosure.

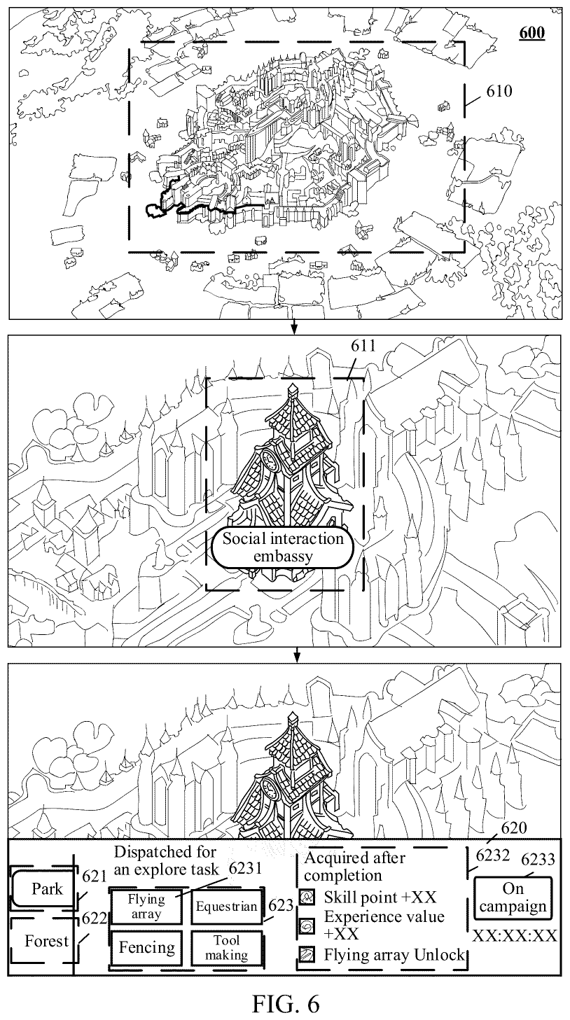

For example, referring to FIG. 6, FIG. 6 is a schematic diagram of a skill acquisition method based on a virtual scene according to another embodiment of this disclosure. As shown in FIG. 6, a client currently displays a virtual scene 600, the virtual scene 600 includes a first virtual tribe 610. In this embodiment, the first virtual tribe 610 is named ““Temple trib””, and the first virtual tribe 610 includes a first virtual building 611 ““Social interaction embass””. A candidate tribe option 620 is displayed in the virtual scene 600 through a trigger operation on the first virtual building 611. The candidate tribe option 620 includes a plurality of candidate tribe options, such as a candidate tribe option 621 corresponding to a candidate virtual tribe ““Par”” and a candidate tribe option 622 corresponding to a candidate virtual tribe ““Fores””.

Operation 422: Display a social interaction option corresponding to the second virtual tribe in response to a selection operation on the option corresponding to the second virtual tribe.

In one embodiment, in response to a click/tap operation of a user on an option corresponding to the second virtual tribe, the client displays social interaction options corresponding to the second virtual tribe. The social interaction options corresponding to the second virtual tribe include identification information of the second virtual tribe and a plurality of candidate skill options corresponding to the second virtual tribe. For example, a selection operation on a second target tribe option refers to performing a social interaction with the second virtual tribe, and the selection operation is configured for viewing a skill owned by a virtual object of the second identity type in the second virtual tribe.

In some embodiments, the candidate skill option refers to an option corresponding to a skill owned by the virtual object of the second identity type. In this embodiment, there is a correspondence between a skill owned by the virtual object and the identity type of which the virtual object is. In other words, virtual objects of different virtual tribes respectively correspond to different identity types, and therefore own different types of skills.

For example, as shown in FIG. 6, by performing a selection operation on the candidate tribe option 621, candidate skill options 623 corresponding to the second virtual tribe ““Par”” are displayed, where candidate skill options 623 include four candidate skill options: a ““Flying arra”” option, an ““Equestria”” option, a ““Fencin”” option, and a ““Tool makin”” option.

In the present disclosure, selection of different virtual tribes and selection of different skills corresponding to the virtual tribes may be implemented through the first virtual building, thereby improving the flexibility of skill selection and improving the user experience.

Operation 431: Display skill attribute information and a select control corresponding to the first skill in response to a preview operation on a first skill option among the candidate skill options.

For example, the first skill option refers to an option corresponding to the first skill. In some embodiments, the preview operation on the first skill option is configured for previewing the skill attribute information of the first skill. The skill attribute information includes an attribute gain effect and skill content corresponding to the first skill, and the select control is configured to trigger to acquire the first skill.

In one embodiment, the preview operation includes at least one of the following operation modes.

1. The preview operation is implemented as a trigger operation on the first skill option, and in response to a trigger operation of a user on the first skill option, the client displays the skill attribute information and the select control of the first skill at a designated position of the virtual scene.

2. The preview operation is implemented as a slide operation on the first skill option, and in response to a slide operation of a user on the first skill option, the skill attribute information and the select control of the first skill are correspondingly displayed at a position where the slide operation is terminated.

The foregoing operation modes of the preview operation are merely schematic examples, which is not limited in the embodiments of the present disclosure.

In one embodiment, the preview operation is performed only on a single first skill option at a time, and skill attribute information corresponding to a selected first skill is selected; or the preview operation may be performed on a plurality of first skill options at a time, and all skill attribute information respectively corresponding to the plurality of selected first skills is displayed, which is not limited.

For example, as shown in FIG. 6, in response to a trigger operation (not shown in FIG. 6) of a user on the first skill option 6231 ““Flight arra”” among the candidate skill options 623, the client displays, in a user interface, skill attribute information 6232 and a select control 6233 corresponding to the first skill ““Flight arra””. the skill attribute information 6232 includes ““Skill point +60; Experience value +50; Unlock flying array skil””.

In the present disclosure, by supporting previewing of an attribute gain effect and skill content of a skill by a user, the user can perform proper skill acquisition, thereby improving the rationality of skill acquisition.

Operation 432: Receive a trigger operation on the select control to serve as the selection operation on the first skill option.

In some embodiments, the select control is configured for determining a first skill option, that is, configured for determining to acquire a first skill.

In one embodiment, the select control corresponds to the first skill option, and in other words, different first skill options correspond to different select controls; or, the select control is configured for determining at least one first skill option finally selected, and in other words, only a single select control is displayed in the virtual scene, the select control is shared by the at least one first skill option, and by triggering the select control, the client may determine that the user selects the at least one first skill option, which is not limited in the embodiments of the present disclosure.

For example, as shown in FIG. 6, a select control 6233 ““On campaig”” is displayed in the virtual scene 600, and when a trigger operation on the select control 6233 is received, the client uses the trigger operation as the selection operation on the first skill option 6231 ““Flight arra””.

In addition, the acquisition process of the first skill corresponds to an acquisition time. As shown in FIG. 6, a corresponding acquisition time ““18 hours 08 minute”” of the first skill in the acquisition process is displayed below the select control 6233. The acquisition time refers to a duration required for completing the acquisition of the first skill.

In a practical case, a designated social interaction virtual object is dispatched from the first virtual building, to acquire the first skill, and in the acquisition time corresponding to the first skill, the designated social interaction virtual object acquires the first skill and returns, so that the virtual object of the first identity type acquires the first skill owned by the virtual object of the second identity type.

In a practical case, when an acquisition duration of the first skill non-reaches the acquisition time, acquisition progress information of the first skill is displayed in response to a trigger operation on the first virtual building in the first virtual tribe, the acquisition progress information including a remaining acquisition time of the first skill.

For example, the case in which the acquisition duration of the first skill non-reaches the acquisition time refers to that the first skill is currently undergoing an acquisition process, and the acquisition time is not yet reached. In other words, the acquisition of the first skill is not yet completed. By triggering the first virtual building again by a user, the remaining acquisition time of the first skill can be viewed, that is, how long it takes to complete the acquisition of the first skill. The acquisition progress information is configured for representing a current acquisition progress of the first skill, where the acquisition progress information includes a remaining acquisition time of the first skill.

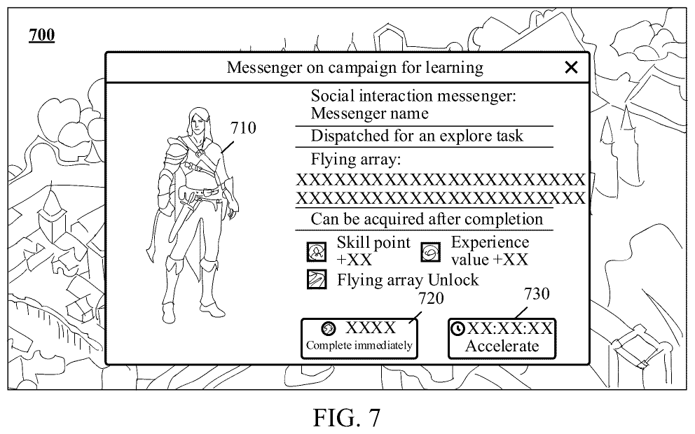

For example, referring to FIG. 7, FIG. 7 is a schematic diagram of an acquisition time according to an embodiment of the present disclosure. As shown in FIG. 7, when acquisition of the first skill ““Flight arra”” is not completed and a trigger operation on the first virtual building is received, the client displays an acquisition interface 700 of the first skill ““Flight arra””. The acquisition interface 700 includes a designated social interaction virtual object 710 ““Social interaction messenge”” dispatched by the first virtual building, so as to acquire the first skill ““Flying arra””. The acquisition interface 700 includes skill attribute information and acquisition progress information ““1 hou”” of the first skill ““Flying arra””, which is configured for indicating that the acquisition process of the current first skill ““Flying arra”” is to be completed in 1 hour. In the present disclosure, by supporting viewing of the acquisition progress of the first skill, the user can reasonably plan the acquisition of the remaining skills, thereby further improving the rationality of the acquisition of skills.

In addition, when the acquisition of the first skill is not completed, the acquisition of the first skill may be completed in advance by using a first acceleration control 720 and a second acceleration control 730, where the first acceleration control 720 is configured for triggering accelerated acquisition of the first skill by using a virtual exchange resource, and the second acceleration control 730 is configured to trigger accelerated acquisition of the first skill by using a designated acceleration prop.

In a practical case, when the acquisition duration of the first skill non-reaches the acquisition time, an interrupt control is displayed in response to the trigger operation on the first virtual building, the interrupt control being configured for interrupting an acquisition progress of the first skill; and an interrupt acquisition result of the first skill is displayed in response to an interrupt operation on the interrupt control, the interrupt acquisition result being configured for instructing the virtual object of the first identity type to acquire the first skill at a proportion corresponding to the acquisition progress when the interrupt operation is performed, and the proportion referring to an attribute representation proportion of the first skill.

For example, the interrupt control is configured for stopping the acquisition of the first skill when the acquisition of the first skill is not completed. In one embodiment, the first virtual tribe may perform acquisition of one skill each time, or may perform acquisition of a plurality of skills at a time, the control may be configured for interrupting the acquisition of one or more skills, which is not limited in the embodiments of the present disclosure.

For example, the interrupt acquisition result refers to a current corresponding acquisition proportion of the first skill after the first skill is stopped by the interrupt control. For example: If the acquisition time of the first skill is 1 hour, and an interrupt operation on the interrupt control is received after the acquisition process lasts half an hour, the client displays an interrupt acquisition result of the first skill, where the interrupt acquisition result includes that the acquisition progress of the first skill is ““50””.

For example, the acquisition progress corresponds to an attribute representation proportion of the first skill. For example, when the current acquisition progress is ““50””, if the skill attribute of the first skill is ““Skill intensity increased by 20””, a skill attribute of a proportion corresponding to the interrupt acquisition result is ““Skill intensity increased by 10””, and in other words, 50% of the original skill attribute of the first skill is acquired.

In a practical case, the first skill may be implemented as a combined skill result corresponding to part skill effects included in at least two skills owned by the virtual object of the second identity type. In other words, by performing a trigger operation on a first skill effect in a first candidate skill option and performing a trigger operation on a second skill effect in the second candidate skill option, the finally acquired first skill includes the first skill effect and the second skill effect. For example, when a skill effect of ““Increase the attack value by 1”” in a skill A is selected and a skill effect of ““Increase the defense value by”” in a skill B is selected, a finally acquired first skill C is implemented as a skill including two skill effects of ““Increase the attack value by 1”” and ““Increase the defense value by””.

Operation 440: When the acquisition of the first skill is completed, display the first skill in a skill list in a process that the virtual object of the first identity type participates in a virtual battle.

Operation 440 is the same as that described in the foregoing embodiment. For content not described in this embodiment of the present disclosure, reference may be made to the foregoing embodiment, and details are not described herein again.

To sum up, in the skill acquisition method based on a virtual scene provided in the embodiments of the present disclosure, through the social interaction options between the first virtual tribe and the second virtual tribe, the virtual object of the first identity type in the first virtual tribe can acquire the skills owned by the virtual object of the second identity type in the second virtual tribe, so that when an identity type of a virtual object is determined, skills corresponding to other identity types can be acquired without transferring the identity type of the virtual object. Therefore, the convenience of acquisition of skills between different identity types is improved, and in particular, when skills corresponding to a plurality of different identity types need to be acquired, both the convenience of acquisition of skills and the acquisition efficiency are high.

In addition, after triggering the social interactions between different virtual tribes, skills owned by virtual objects of different identity types are acquired, so that during a virtual battle, a virtual object can own all of the skills corresponding to the different identity types without changing the identity type, thereby improving the diversity of skill acquisition, avoiding a plurality of times of identity type transforms of a user in the process of acquiring skills corresponding to the different identity types, and reducing the data overhead of the computer.

In addition, by performing a preview operation on the first skill option, a player may preview the skill attribute information corresponding to the first skill, so as to select the first skill option by performing a trigger operation on the select control, so that the player can preview the first skill in advance, thereby improving the autonomy in selecting the first skill.

In addition, by displaying the acquisition progress information, the acquisition progress of the current first skill can be provided in real time, and the player can respond to the prompt, thereby improving the skill acquisition efficiency.

In addition, by performing an interrupt operation on the interrupt control, the first skill is acquired according to a proportion corresponding to the acquisition progress, so as to acquire the first skill corresponding to the attribute representation proportion, so that the diversity of acquisition modes of the first skill is improved.

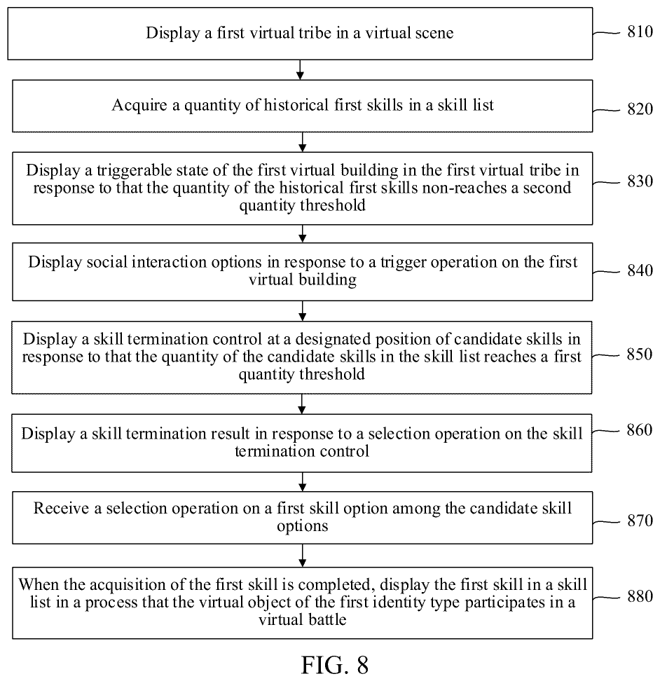

In one embodiment, when the acquisition of the first skill is completed, the client further displays acquisition completion prompt information. For example, referring to FIG. 8, FIG. 8 is a flowchart of a skill acquisition method based on a virtual scene according to another embodiment of the present disclosure. As shown in FIG. 8, the method includes the following operations.

Operation 810: Display a first virtual tribe in a virtual scene.

The first virtual tribe is a virtual tribe corresponding to a virtual object of a first identity type in the virtual scene; and the first virtual tribe includes a first virtual building, the first virtual building being configured for initiating a social interaction between virtual tribes.

For example, the first virtual building is configured to acquire a skill owned by a virtual object of another identity type of another virtual tribe by dispatching a designated social interaction virtual object.

In some embodiments, a social iteration can be initiated through the first virtual building only when a character grade of the virtual object of the first identity type reaches a designated grade. For example, when the character grade of a member A is greater than or equal to grade 30, the virtual object of the first identity type can acquire a skill owned by a member B through the first virtual building. Identity types respectively corresponding to the member A and the member B are different.

Operation 820: Acquire a quantity of historical first skills in a skill list.

The historical first skills refer to skills owned by the virtual object of the second identity type acquired within a designated historical period of time. The designated historical period of time may refer to a historical period of time before a current moment, or may refer to a historical period of time before a set moment, which is not limited in the embodiments of the present disclosure. For example, the historical first skills refer to skills of virtual objects of other identity types that are acquired by the virtual building within the designated historical period of time.

In some embodiments, the historical first skills may be determined by determining skill information respectively corresponding to skills already existing in the skill list. The skill information includes a skill name, skill content, a skill gain effect, a skill acquisition moment, or the like.

Operation 830: Display a triggerable state of the first virtual building in the first virtual tribe in response to that the quantity of the historical first skills non-reaches a second quantity threshold.

For example, there is a quantity limit on the quantity of skills that correspond to other identity types and can be simultaneously owned by the virtual object. In other words, if the quantity of skills corresponding to the second identity type owned by the current virtual object of the first identity type reaches a second quantity threshold, the quantity of skills corresponding to other identity types that can be owned by the current virtual object of the first identity type is saturated.

In some embodiments, when the quantity of the historical first skills non-reaches the second quantity threshold, the client displays the triggerable state of the first virtual building. The triggerable state of the first virtual building is configured for representing that the current first virtual building can be configured for initiating a social interaction between virtual tribes. In addition, a non-triggerable state of the first virtual building is configured for representing that the first virtual building is currently not available for initiating a social interaction between virtual tribes. The second quantity threshold may be set and adjusted according to actual use requirements, which is not limited in the embodiments of the present disclosure.

Operation 840: Display social interaction options in response to a trigger operation on the first virtual building.

The social interaction options including identification information of a second virtual tribe and candidate skill options corresponding to the second virtual tribe, the second virtual tribe is a virtual tribe corresponding to a virtual object of a second identity type in the virtual scene, and skills corresponding to the candidate skill options are skills owned by the virtual object of the second identity type.

In one embodiment, the first virtual building corresponds to a plurality of different types of social interactions; or different virtual buildings correspondingly initiate different types of social interactions, which is not limited in the embodiments of the present disclosure.

Operation 850: Display a skill termination control at a designated position of candidate skills in response to that the quantity of the candidate skills in the skill list reaches a first quantity threshold.

The skill termination control is configured for terminating use of the candidate skills. The first quantity threshold and the designated position may be set and adjusted according to actual use requirements.

For example, the candidate skills refer to skills owned by the current virtual object of the first identity type. In other words, the candidate skills include at least one of the following: a skill inherently owned by the virtual object of the first identity type, or a skill (first skill) owned by the virtual object of the second identity type and acquired by the virtual object of the first identity type through the first virtual building.

In some embodiments, there is also a quantity threshold for the quantity of the candidate skills simultaneously owned by the virtual object of the first identity type. In other words, when the quantity of the candidate skills reaches the first quantity threshold, the current quantity of candidate skills reaches a saturation state.

For example, if the quantity of the candidate skills reaches the saturation state, use of a candidate skill may be terminated by using the skill termination control, so as to subsequently continue to acquire a skill of the virtual object corresponding to the second identity type. Therefore, the skill termination control is configured for terminating use of the candidate skills.

Operation 860: Display a skill termination result in response to a selection operation on the skill termination control.

For example, a skill termination control is displayed at a designated position of each candidate skill, and when a trigger operation on the designated skill termination control is received, a skill termination result of the candidate skill corresponding to the designated skill termination control is displayed, where the skill termination result is configured for indicating termination of use of the candidate skill.

Operation 870: Receive a selection operation on a first skill option among the candidate skill options.

The selection operation is configured for triggering acquisition of a first skill corresponding to the first skill option.

Content of the first skill option in operation 870 is described in detail in operation 430, and details are not described herein again.

Operation 880: When the acquisition of the first skill is completed, display the first skill in a skill list in a process that the virtual object of the first identity type participates in a virtual battle.

For example, when the acquisition of the first skill is completed and the virtual object of the first identity type participates in the virtual battle, the first skill may be displayed in the skill list for use by the virtual object of the first identity type.

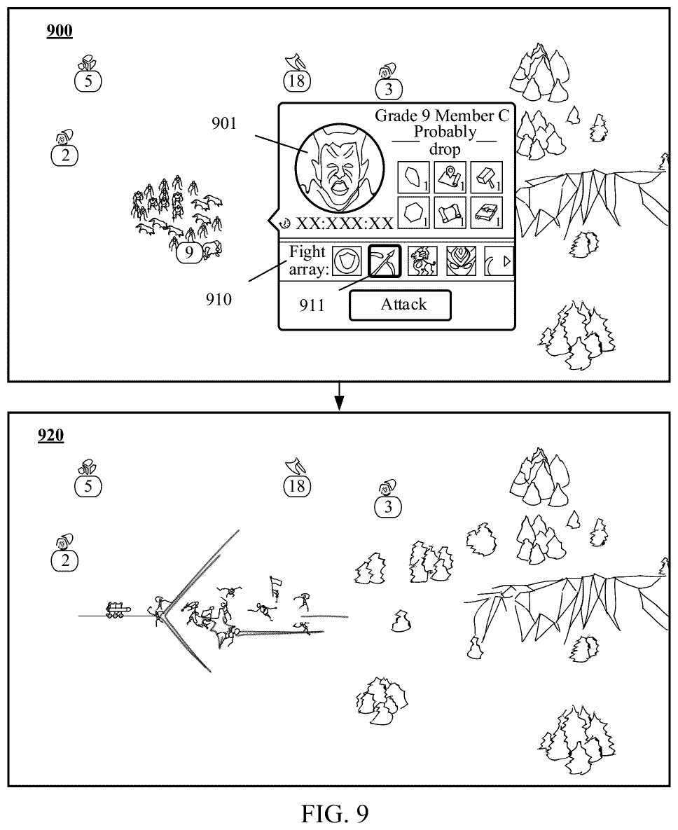

For example, referring to FIG. 9, FIG. 9 is a schematic diagram of a first skill according to an embodiment of the present disclosure. As shown in FIG. 9, a client currently displays a virtual environment 900; in the virtual environment 900, a virtual object 901 ““Member”” of a first identity type is performing a virtual battle, and the client currently displays a skill list 910 of the virtual object 901, the skill list including a first skill 911 ““Flight arra””, where skill attributes corresponding to ““Flying arra”” include increasing the defense effect by 1% and increase the moving speed by 5%. In response to a trigger operation on the first skill 911 ““Flying arra””, the ““Member”” is displayed in a form of the ““Flying arra”” during a battle, the ““Member”” acquires a corresponding skill attribute, and then the client displays a corresponding battle effect animation 920 in a user interface.

In a practical case, the client displays acquisition completion prompt information in response to completion of the acquisition of the first skill; and displays a skill unlocking animation in response to a trigger operation on the acquisition completion prompt information, the skill unlocking animation including attribute information corresponding to the first skill.

The acquisition completion prompt information is configured for prompting the user of the completion of the acquisition of the first skill. A skill unlocking animation is configured for prompting the user that the first skill is unlocked and the virtual object of the first identity type may use the first skill.

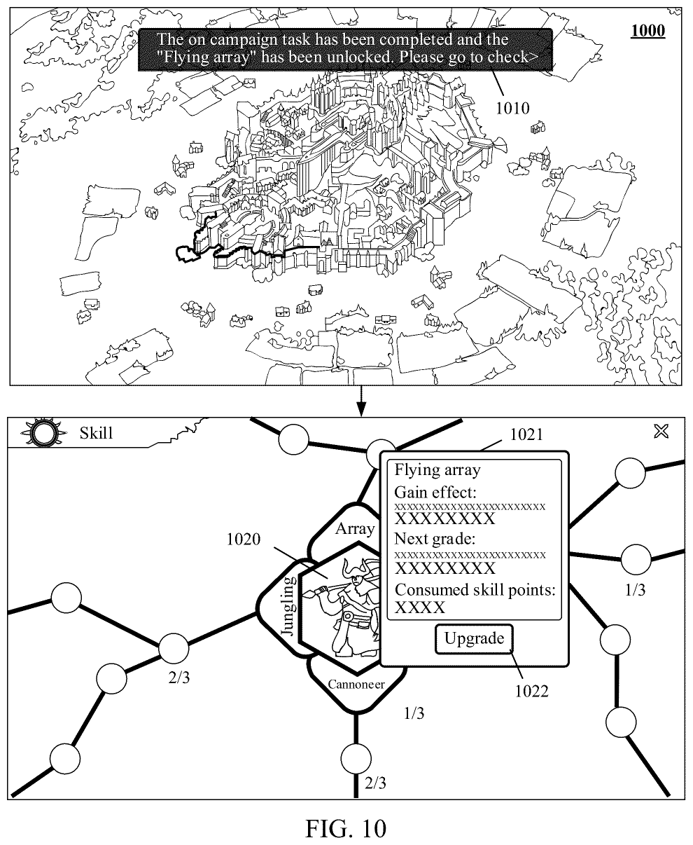

For example, in response to the completion of the acquisition of the first skill, the client further displays the acquisition completion prompt information, to indicate that the first skill is completely acquired currently. Referring to FIG. 10, FIG. 10 is a schematic diagram of acquisition completion prompt information according to an embodiment of the present disclosure. As shown in FIG. 10, a client currently displays a virtual scene 1000, and when the acquisition of the first skill is completed, the client displays acquisition completion prompt information 1010 in a virtual scene.

For example, the skill unlocking animation refers to an animation that triggers to unlock an available state of the first skill after the acquisition of the first skill is completed. Attribute information of the first skill refers to a skill effect corresponding to the first skill. As shown in FIG. 10, in response to a trigger operation on the acquisition completion prompt information 1010, the client displays a skill unlocking animation 1020. The skill unlocking animation 1020 includes attribute information 1021 corresponding to a first skill ““Flying arra”” to display skill details of the first skill.

In a practical case, the client further displays an attribute promotion control, the attribute promotion control being configured for promoting a skill attribute of the first skill; and displays an attribute promotion result of the first skill in response to a trigger operation on the attribute promotion control, the attribute promotion result being correlated with a number of times of trigger operations on the attribute promotion control.

For example, after the acquisition of the first skill is completed, an attribute promotion control is displayed in the virtual scene, and a user may promote the skill attribute of the first skill by triggering the attribute promotion control. For example: the current first skill is ““Increase the attack power by 10 point””, and after the attribute promotion control is triggered, the first skill is ““Increase the attack power by 15 point””, to serve as the attribute promotion result. The attribute promotion result may be configured for indicating a degree of promotion of the attribute of the first skill.

A greater number of times of triggering the attribute promotion control indicates a higher attribute promotion effect of the first skill. As shown in FIG. 10, the skill unlocking animation 1020 further includes an attribute promotion control 1022 ““Upgrad””, which may be configured for upgrading the first skill. When a trigger operation on the attribute promotion control 1022 is received, the client displays the attribute promotion result (not shown) of the first skill. A greater number of trigger operations indicates a higher skill grade of the first skill and indicates a better skill attribute.

In a practical case, the client displays a skill fusion result in response to a skill fusion operation, the skill fusion operation being configured for performing attribute fusion on a skill owned by the virtual object of the first identity type in the skill list and the first skill.

For example, after the acquisition of the first skill is completed, the client may fuse the first skill with a skill inherently owned by the virtual object of the first identity type to generate a new skill, to serve as the skill fusion result. In the process of generating the new skill through skill fusion, attributes of the newly generated skill integrates respective skill attributes of the first skill and the skill inherently owned by the virtual object of the first identity type. For example: If a skill 1 is ““Increase the attack value by 1”” and a skill 2 is ““Increase the defense value by””, the skill 1 and the skill 2 may be fused through a skill fusion operation, to generate a skill 3 ““Increase the resistance value by””.

To sum up, in the skill acquisition method based on a virtual scene provided in the embodiments of the present disclosure, through the social interaction options between the first virtual tribe and the second virtual tribe, the virtual object of the first identity type in the first virtual tribe can acquire the skills owned by the virtual object of the second identity type in the second virtual tribe, so that when an identity type of a virtual object is determined, skills corresponding to other identity types can be acquired without transferring the identity type of the virtual object. Therefore, the convenience of acquisition of skills between different identity types is improved, and in particular, when skills corresponding to a plurality of different identity types need to be acquired, both the convenience of acquisition of skills and the acquisition efficiency are high.

In addition, after triggering the social interactions between different virtual tribes, skills owned by virtual objects of different identity types are acquired, so that during a virtual battle, a virtual object can own all of the skills corresponding to the different identity types without changing the identity type, thereby improving the diversity of skill acquisition, avoiding a plurality of times of identity type transforms of a user in the process of acquiring skills corresponding to the different identity types, and reducing the data overhead of the computer.

In addition, when the acquisition of the first skill is completed, the acquisition completion prompt information is displayed, to prompt a player that the acquisition of the current first skill is completed, so that an information indication capability of the completion of the skill is enhanced, thereby helping to improve the user experience.

In addition, the skill attribute of the first skill is promoted by triggering the attribute promotion control, so that the diversity of skill acquisition and the value and optimizability of the first skill are improved, thereby helping to improve the viscosity of users to the target application.

In addition, when the quantity of the candidate skills in the skill list reaches the first quantity threshold, the use of a skill currently owned may be terminated through the skill termination control, thereby leaving room for acquiring a new first skill and improving the diversity of acquisition of skills.

In addition, the second quantity threshold is provided for the historical first skills, to control the virtual object to acquire a first skill within a limited amount, so that a player needs to formulate a relevant skill acquisition strategy, thereby improving the game interactivity of the player and helping to improve the viscosity of users to the target application.

In addition, a new skill is acquired through a skill fusion operation, thereby improving the diversity of skill acquisition methods.

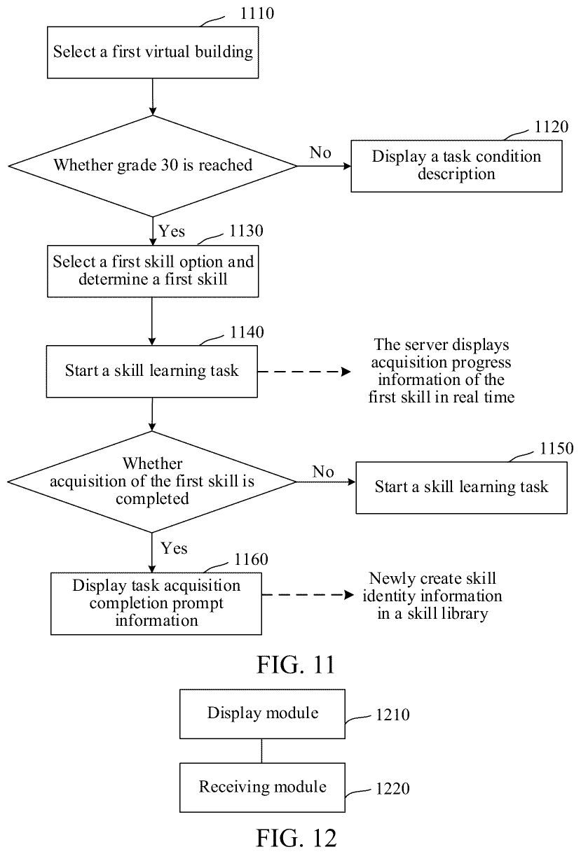

For example, referring to FIG. 11, FIG. 11 is a flowchart of a skill acquisition method based on a virtual scene according to another embodiment of the present disclosure. The method is applied to a scene in which a game task is ““Cross-tribal skill learnin””. As shown in FIG. 11, the method includes the following operations.

Operation 1110: Select a first virtual building.

Currently, a player is in a task scene of cross-tribal skill learning. In the current scene, the player needs to control a virtual object of a first identity type in a first virtual tribe ““Templ””, to acquire a skill owned by a virtual object of a second identity type in a second virtual tribe ““Par””. A social interaction corresponding to acquisition of skills between different virtual tribes is initiated by selecting a first virtual building ““Social interaction embass””.

Before acquiring a cross-tribal skill learning task, a server acquires a storage state of a task variable table corresponding to the task. If all task variables in the task variable table are used currently, the virtual object of the first identity type currently controlled by the player has acquired all the skills owned by the virtual object of the second identity type, and in this case, the virtual object of the first identity type can no longer acquire a skill owned by the virtual object of the second identity type, but can perform a skill attribute promotion operation on a currently owned skill.

If not all of the task variables are used, the current virtual object may receive the cross-tribal learning task, and in a subsequent process of acquiring the first skill, a designated value marked corresponding to the first skill is recorded in the task variable table, the designated value being configured for indicating that acquisition of the first skill in the current task is completed.

In this embodiment, the current task variable has a storage space (that is, a skill can still be acquired), and therefore the triggerable state of the ““Social interaction embass”” is displayed, and after the ““Social interaction embass”” is selected, a character grade of the virtual object of the current first identity type is determined; if the grade is greater than or equal to a preset grade (for example: 30 grades), operation 1130 is performed; and if the grade is less than the preset grade, operation 1120 is performed.

Operation 1120: Display a task condition description.

When the character grade of the virtual object of the first identity type is less than the preset grade, the client displays a task prompt description ““You currently do not meet the conditions for cross-tribal skill learning, and you can acquire the task when your character grade reaches grade 3””, to serve as the task condition description.

Operation 1130: Select a first skill option and determine a first skill.

When the virtual object of the first identity type reaches the preset grade, the client displays social interaction options in response to a selection operation on the first virtual building. The social interaction options include identification information of the second virtual tribe ““Par”” and candidate skill options ““Flying Arra””, ““Equestria””, ““Fencin””, and ““Tool makin”” corresponding to the second virtual tribe ““Par””. Different task rewards and acquisition times for acquiring skills are displayed correspondingly for different candidate skill options.

The first skill option ““Flying arra”” is selected as the first skill to be acquired.

Operation 1140: Start a skill learning task.

After determining that the first skill is ““Flying arra””, the ““Social interaction embass”” dispatches a designated social interaction virtual object to acquire the first skill ““Flying arra””, and the corresponding acquisition time is 18 hours and 08 minutes.

If the acquisition of the first skill is completed, operation 1160 is performed; or if the acquisition of the first skill is not completed, operation 1150 is performed.

Operation 1150: Display task information, task status, and a task acquisition progress.

During the acquisition of the first skill, the client displays acquisition progress information of the first skill in real time, where the acquisition progress information includes task information of the cross-tribal skill learning, and a task state (a remaining acquisition time of the first skill) and a task acquisition progress (a current acquisition proportion of the first skill) of the cross-tribal skill learning.

Operation 1160: Display task acquisition completion prompt information.

A corresponding designated character string when the task of the cross-tribal skill learning is completed is set. During the cross-tribal skill learning, when the acquisition of the first skill is completed, an array subscript corresponding to the designated character string is set to 1, to mark that the acquisition of the first skill is completed, and a task variable record corresponding to the first skill in the task variable table is deleted, to indicate that the cross-tribal skill learning is completed.

When the acquisition of the first skill is completed, skill identity information (ID) is newly created in a skill library of the virtual object of the first identity type, where the skill ID includes a skill name ID, a skill basic attribute ID, a skill gain type ID, a skill gain proportion ID, a skill cooling time ID, a skill grade ID, or the like.

In one embodiment, the execution body of operation 1110 to operation 1160 is a client.

To sum up, in the skill acquisition method based on a virtual scene provided in the embodiments of the present disclosure, through the social interaction options between the first virtual tribe and the second virtual tribe, the virtual object of the first identity type in the first virtual tribe can acquire the skills owned by the virtual object of the second identity type in the second virtual tribe, so that when an identity type of a virtual object is determined, skills corresponding to other identity types can be acquired without transferring the identity type of the virtual object. Therefore, the convenience of acquisition of skills between different identity types is improved, and in particular, when skills corresponding to a plurality of different identity types need to be acquired, both the convenience of acquisition of skills and the acquisition efficiency are high.

In addition, after triggering the social interactions between different virtual tribes, skills owned by virtual objects of different identity types are acquired, so that during a virtual battle, a virtual object can own all of the skills corresponding to the different identity types without changing the identity type, thereby improving the diversity of skill acquisition, avoiding a plurality of times of identity type transforms of a user in the process of acquiring skills corresponding to the different identity types, and reducing the data overhead of the computer.

FIG. 12 is a structural block diagram of a skill acquisition apparatus based on a virtual scene according to an embodiment of the present disclosure. As shown in FIG. 12, the apparatus includes the following parts:

a display module 1210, configured to display a first virtual tribe in the virtual scene, the first virtual tribe being a virtual tribe corresponding to a virtual object of a first identity type in the virtual scene;

the display module 1210 being further configured to display social interaction options, the social interaction options including identification information of a second virtual tribe and candidate skill options corresponding to the second virtual tribe, the second virtual tribe being a virtual tribe corresponding to a virtual object of a second identity type in the virtual scene, and skills corresponding to the candidate skill options being skills owned by the virtual object of the second identity type;

a receiving module 1220, configured to receive a selection operation on a first skill option among the candidate skill options, the selection operation being configured for triggering acquisition of a first skill corresponding to the first skill option; and

the display module 1210 being further configured to: when the acquisition of the first skill is completed, display the first skill in a skill list in a process that the virtual object of the first identity type participates in a virtual battle.

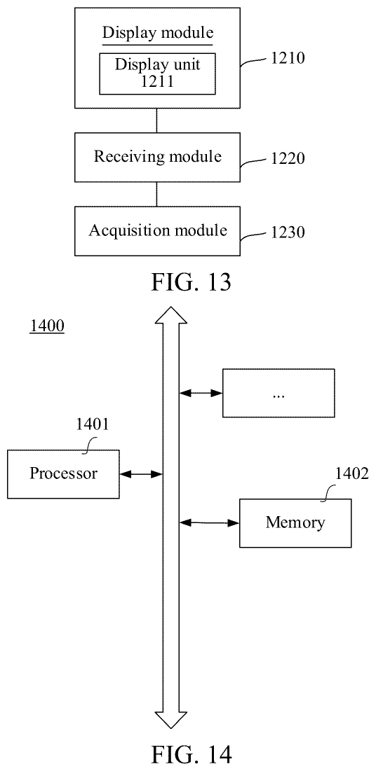

In some embodiments, the first virtual tribe includes a first virtual building, the first virtual building being configured for initiating a social interaction between virtual tribes. As shown in FIG. 13, the display module 1210 further includes: a display unit 1211.

The display unit 1211 is configured to display candidate tribe options in response to an operation on the first virtual building, the candidate tribe options including an option corresponding to the second virtual tribe; and

the display unit 1211 is further configured to display a social interaction option corresponding to the second virtual tribe in response to a selection operation on the option corresponding to the second virtual tribe.

In some embodiments, the receiving module 1220 is further configured to display skill attribute information and a select control corresponding to the first skill in response to a preview operation on the first skill option among the candidate skill options; and receive a trigger operation on the select control to serve as the selection operation on the first skill option.

In some embodiments, the acquisition process of the first skill corresponds to an acquisition time; and

The display module 1210 is further configured to: when an acquisition duration of the first skill non-reaches the acquisition time, display acquisition progress information of the first skill in response to a trigger operation on the first virtual building in the first virtual tribe, the acquisition progress information including a remaining acquisition time of the first skill.

In some embodiments, the display module 1210 is further configured to: when the acquisition duration of the first skill non-reaches the acquisition time, display an interrupt control in response to the trigger operation on the first virtual building, the interrupt control being configured for interrupting an acquisition progress of the first skill; and display an interrupt acquisition result of the first skill in response to an interrupt operation on the interrupt control, the interrupt acquisition result being configured for instructing the virtual object of the first identity type to acquire the first skill at a proportion corresponding to the acquisition progress when the interrupt operation is performed, and the proportion referring to an attribute representation proportion of the first skill.

In some embodiments, the display module 1210 is further configured to display acquisition completion prompt information in response to completion of the acquisition of the first skill; and display a skill unlocking animation in response to a trigger operation on the acquisition completion prompt information, the skill unlocking animation including attribute information corresponding to the first skill.

In some embodiments, the display module 1210 is further configured to display an attribute promotion control, the attribute promotion control being configured for promoting a skill attribute of the first skill; and display an attribute promotion result of the first skill in response to a trigger operation on the attribute promotion control, the attribute promotion result being correlated with a number of times of trigger operations on the attribute promotion control.

In some embodiments, the display module 1210 is further configured to display a skill termination control at a designated position of candidate skills in response to that a quantity of the candidate skills in the skill list reaches a first quantity threshold, the skill termination control being configured for terminating use of the candidate skills; and display a skill termination result in response to a selection operation on the skill termination control.

In some embodiments, as shown in FIG. 13, the apparatus further includes: an acquisition module 1230.

The acquisition module 1230 is configured to acquire a quantity of historical first skills in the skill list, the historical first skills referring to skills owned by the virtual object of the second identity type acquired within a designated historical period of time; and

The display module 1210 is further configured to display a triggerable state of the first virtual building in the first virtual tribe in response to that the quantity of the historical first skills non-reaches a second quantity threshold.

In some embodiments, the display module 1210 is further configured to display a skill fusion result in response to a skill fusion operation, the skill fusion operation being configured for performing attribute fusion on a skill owned by the virtual object of the first identity type in the skill list and the first skill.

To sum up, in the skill acquisition apparatus based on a virtual scene provided in the embodiments of the present disclosure, through the social interaction options between the first virtual tribe and the second virtual tribe, the virtual object of the first identity type in the first virtual tribe can acquire the skills owned by the virtual object of the second identity type in the second virtual tribe, so that when an identity type of a virtual object is determined, skills corresponding to other identity types can be acquired without transferring the identity type of the virtual object. Therefore, the convenience of acquisition of skills between different identity types is improved, and in particular, when skills corresponding to a plurality of different identity types need to be acquired, both the convenience of acquisition of skills and the acquisition efficiency are high.

In addition, after triggering the social interactions between different virtual tribes, skills owned by virtual objects of different identity types are acquired, so that during a virtual battle, a virtual object can own all of the skills corresponding to the different identity types without changing the identity type, thereby improving the diversity of skill acquisition, avoiding a plurality of times of identity type transforms of a user in the process of acquiring skills corresponding to the different identity types, and reducing the data overhead of the computer.

According to the skill acquisition apparatus based on a virtual scene provided in the foregoing embodiments, the foregoing functional modules are only described for purposes of providing examples. In actual applications, the functions may be allocated to different functional modules according to specific needs, which means that the internal structure of the device is divided into different functional modules to complete all or some of the foregoing functions. In addition, the skill acquisition apparatus based on a virtual scene provided in the foregoing embodiments and the embodiments of the skill acquisition method based on a virtual scene fall within a same conception. For details of a specific implementation process, refer to the method embodiments. Details are not described herein again.

FIG. 14 is a structural block diagram of a terminal device 1400 according to an embodiment of the present disclosure. The terminal device 1400 may be: a smartphone, a tablet, an MP3 player, an MP4 player, a laptop, a desktop computer, or the like. The terminal 1400 may alternatively be referred to as another name such as a terminal, user equipment, a portable terminal, a laptop terminal, or a desktop terminal.

Generally, terminal device 1400 includes: processing circuitry, such as a processor 1401, and a memory 1402.

The processor 1401 may include one or more processing cores, for example, a 4-core processor or an 8-core processor. The processor 1401 may be implemented in at least one hardware form of a digital signal processor (DSP), a field-programmable gate array (FPGA), and a programmable logic array (PLA). The processor 1401 may alternatively include a main processor and a coprocessor, and the main processor is a processor for processing data in a wake-up state, also referred to as a central processing unit (CPU). The coprocessor is a low power consumption processor for processing data in a standby state. In some embodiments, the processor 1401 may be integrated with a graphics processing unit (GPU). The GPU is configured to render and draw content that needs to be displayed on a display screen. In some embodiments, the processor 1401 may further include an artificial intelligence (AI) processor. The AI processor is configured to process computing operations related to machine learning.

The memory 1402 may include one or more computer-readable storage media. The computer-readable storage medium may be non-transient. The memory 1402 may further include a high-speed random access memory and a nonvolatile memory, for example, one or more disk storage devices or flash storage devices. In some embodiments, a non-transitory computer-readable storage medium in the memory 1402 is configured to store at least one instruction, and the at least one instruction being configured for being executed by the processor 1401 to perform the skill acquisition method based on a virtual scene provided in the method embodiments of the present disclosure.

In some embodiments, the terminal device 1400 further includes other components. A person skilled in the art may understand that the structure shown in FIG. 14 constitutes no limitation on the terminal device 1400, and the terminal may include more or fewer components than those shown in the figure, or some components may be combined, or a different component deployment may be configured.

It is noted that all or some of the operations of the methods in the embodiments may be implemented by a program instructing relevant hardware. The program may be stored in a computer-readable storage medium, such as a non-transitory computer-readable storage medium. The computer-readable storage medium may be the computer-readable storage medium included in the memory in the foregoing embodiments, or may be a computer-readable storage medium that exists independently and that is not assembled in a terminal device. The computer-readable storage medium stores at least one program. The at least one program is loaded and executed by a processor to perform the skill acquisition method based on a virtual scene provided in the foregoing method embodiments.

In one embodiment, the computer-readable storage medium may include: a read-only memory (ROM), a random access memory (RAM), a solid state drive (SSD), an optical disc, or the like. The RAM may include a resistance random access memory (ReRAM) and a dynamic random access memory (DRAM). The sequence numbers of the foregoing embodiments of the present disclosure are merely for description purpose but do not imply the preference among the embodiments.

It is noted that all or some of the operations of the foregoing embodiments may be implemented by hardware, or may be implemented by a program instructing relevant hardware, the program may be stored in a computer-readable storage medium, and the storage medium may be a read-only memory, a magnetic disk, an optical disc, or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

An embodiment further provides a computer program product, the computer program product including a computer instruction, and the computer instruction being stored in a computer-readable storage medium. A processor of a terminal device reads the computer instruction from the computer-readable storage medium, and the processor executes the computer instruction, to cause the terminal device to perform a skill acquisition method based on a virtual scene described above. ““Plurality o”” mentioned in the specification means two or more. ““And/o”” describes an association relationship for describing associated objects and represents that three relationships may exist. For example, A and/or B may represent the following three cases: Only A exists, both A and B exist, and only B exists. The character ““ ”” in this specification generally indicates an ““o”” relationship between the associated objects. In addition, the operation numbers described in this specification merely exemplarily show a possible execution sequence of the operations. In some other embodiments, the operations may not be performed according to the number sequence. For example, two operations with different numbers may be performed simultaneously, or two operations with different numbers may be performed according to a sequence contrary to the sequence shown in the figure. This is not limited in the embodiments of the present disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are merely examples of embodiments of the present disclosure, and are not intended to limit this application. Any modification, equivalent replacement, or improvement made within the spirit and principle of this application shall fall within the protection scope of this application.

What is claimed is:

1. A method for skill acquisition in a virtual scene, comprising:
displaying a first virtual tribe in the virtual scene, the first virtual tribe being a virtual tribe with one or more first virtual objects of a first identity type in the virtual scene, a first set of skills being associated with the first virtual tribe;
displaying social interaction options for an acquisition of one or more skills across different virtual tribe by at least a first virtual object in the one or more first virtual objects of the first identity type, the social interaction options comprising identification information of a second virtual tribe, and candidate skill options for a second set of skills associated with the second virtual tribe, the second virtual tribe being a virtual tribe with one or more second virtual objects of a second identity type in the virtual scene;
receiving a selection operation on a first skill option among the candidate skill options, the first skill option corresponding to a first skill in the second set of skills associated with the second virtual tribe, the selection operation on the first skill option indicating a triggering of an acquisition of the first skill corresponding to the first skill option; and
when the acquisition of the first skill is completed, displaying the first skill in a skill list of candidate skills for use by the first virtual object in the one or more first virtual objects of the first identity type in a process that the first virtual object of the first identity type participates in a virtual battle.

2. The method according to claim 1, wherein the first virtual tribe comprises a first virtual building, the first virtual building is configured to initiate a social interaction between virtual tribes, the displaying the social interaction options comprises:
displaying one or more candidate tribe options in response to an operation on the first virtual building, the one or more candidate tribe options comprising a first option corresponding to the second virtual tribe; and
displaying a social interaction option with the candidate skill options of the second set of skills associated with the second virtual tribe in response to a selection operation on the first option corresponding to the second virtual tribe.

3. The method according to claim 1, wherein the receiving comprises:
displaying skill attribute information and a select control associated with the first skill in response to a preview operation on the first skill option; and
receiving a trigger operation on the select control that indicates the selection operation on the first skill option.

4. The method according to claim 2, wherein the acquisition of the first skill is defined based on an acquisition time, and the method further comprises:
when an acquisition duration of the first skill is shorter than the acquisition time, displaying acquisition progress information of the first skill in response to a trigger operation on the first virtual building in the first virtual tribe, the acquisition progress information comprising a remaining acquisition time of the first skill.

5. The method according to claim 4, further comprising:
when the acquisition duration of the first skill is shorter than the acquisition time, displaying an interrupt control in response to the trigger operation on the first virtual building, the interrupt control being configured for interrupting the acquisition of the first skill; and
displaying an interrupt acquisition result of the first skill in response to an interrupt operation on the interrupt control, the interrupt acquisition result being configured to indicate a proportion of the acquisition of the first skill by the first virtual object when the interrupt operation is performed.

6. The method according to claim 1, further comprising:
displaying an acquisition completion prompt in response to a completion of the acquisition of the first skill; and
displaying a skill unlocking animation in response to a trigger operation on the acquisition completion prompt, the skill unlocking animation comprising attribute information of the first skill.

7. The method according to claim 6, further comprising:
displaying an attribute promotion control, the attribute promotion control being configured to promote a skill attribute of the first skill; and
displaying an attribute promotion result of the first skill in response to a trigger operation on the attribute promotion control, the attribute promotion result being correlated with a number of times of trigger operations on the attribute promotion control.

8. The method according to claim 1, further comprising:
displaying a skill termination control at a designated position of a candidate skill in the skill list when a quantity of the candidate skills in the skill list reaches a first quantity threshold, the skill termination control being configured to terminate the candidate skill; and
displaying a skill termination result in response to a selection operation on the skill termination control.

9. The method according to claim 2, further comprising:
acquiring a quantity of historical first skills in the skill list, the historical first skills being associated with the one or more second virtual objects of the second identity type and being acquired by the first virtual object within a designated historical period of time; and
displaying a triggerable state of the first virtual building in the first virtual tribe when the quantity of the historical first skills is less than a second quantity threshold.

10. The method according to claim 1, further comprising:
displaying a skill fusion result in response to a skill fusion operation, the skill fusion operation performing attribute fusion on a skill owned by the first virtual object of the first identity type in the skill list with the first skill.

11. An apparatus, comprising processing circuitry configured to:
display a first virtual tribe in a virtual scene, the first virtual tribe being a virtual tribe with one or more first virtual objects of a first identity type in the virtual scene, a first set of skills being associated with the first virtual tribe;
display social interaction options for an acquisition of one or more skills across different virtual tribe by at least a first virtual object in the one or more first virtual objects of the first identity type, the social interaction options comprising identification information of a second virtual tribe, and candidate skill options for a second set of skills associated with the second virtual tribe, the second virtual tribe being a virtual tribe with one or more second virtual objects of a second identity type in the virtual scene, and the second set of skills associated with the second virtual tribe being associated with the one or more second virtual objects of the second identity type;
receive a selection operation on a first skill option among the candidate skill options, the first skill option corresponding to a first skill in the second set of skills associated with the second virtual tribe, the selection operation on the first skill option indicating a triggering of an acquisition of the first skill corresponding to the first skill option; and
when the acquisition of the first skill is completed, display the first skill in a skill list of candidate skills for use by a first virtual object in the one or more first virtual objects of the first identity type in a process that the first virtual object participates in a virtual battle.

12. The apparatus according to claim 11, wherein the first virtual tribe comprises a first virtual building, the first virtual building is configured to initiate a social interaction between virtual tribes, the processing circuitry is configured to:
display one or more candidate tribe options in response to an operation on the first virtual building, the one or more candidate tribe options comprising a first option corresponding to the second virtual tribe; and
display a social interaction option with the candidate skill options of the second set of skills associated with the second virtual tribe in response to a selection operation on the first option corresponding to the second virtual tribe.

13. The apparatus according to claim 11, wherein the processing circuitry is configured to:
display skill attribute information and a select control associated with the first skill in response to a preview operation on the first skill option; and
receive a trigger operation on the select control that indicates the selection operation on the first skill option.

14. The apparatus according to claim 12, wherein the acquisition of the first skill is defined based on an acquisition time, the processing circuitry is configured to:
when an acquisition duration of the first skill is shorter than the acquisition time, displaying acquisition progress information of the first skill in response to a trigger operation on the first virtual building in the first virtual tribe, the acquisition progress information comprising a remaining acquisition time of the first skill.

15. The apparatus according to claim 14, wherein the processing circuitry is configured to:
When the acquisition duration of the first skill is shorter than the acquisition time, display an interrupt control in response to the trigger operation on the first virtual building, the interrupt control being configured to interrupt the acquisition of the first skill; and
display an interrupt acquisition result of the first skill in response to an interrupt operation on the interrupt control, the interrupt acquisition result being configured to indicate a proportion of the acquisition of the first skill by the first virtual object when the interrupt operation is performed.

16. The apparatus according to claim 11, wherein the processing circuitry is configured to:
display an acquisition completion prompt in response to a completion of the acquisition of the first skill; and
display a skill unlocking animation in response to a trigger operation on the acquisition completion prompt, the skill unlocking animation comprising attribute information of the first skill.

17. The apparatus according to claim 16, wherein the processing circuitry is configured to:
display an attribute promotion control, the attribute promotion control being configured to promote a skill attribute of the first skill; and
display an attribute promotion result of the first skill in response to a trigger operation on the attribute promotion control, the attribute promotion result being correlated with a number of times of trigger operations on the attribute promotion control.

18. The apparatus according to claim 11, wherein the processing circuitry is configured to:
display a skill termination control at a designated position of a candidate skill in the skill list when a quantity of the candidate skills in the skill list reaches a first quantity threshold, the skill termination control being configured to terminate the candidate skill; and
display a skill termination result in response to a selection operation on the skill termination control.

19. The apparatus according to claim 12, wherein the processing circuitry is configured to:
acquire a quantity of historical first skills in the skill list, the historical first skills being associated with the one or more second virtual objects of the second identity type and being acquired by the first virtual object within a designated historical period of time; and
display a triggerable state of the first virtual building in the first virtual tribe when the quantity of the historical first skills is less than a second quantity threshold.

20. The apparatus according to claim 11, wherein the processing circuitry is configured to:
display a skill fusion result in response to a skill fusion operation, the skill fusion operation performing attribute fusion on a skill owned by the first virtual object of the first identity type in the skill list with the first skill.
